(19) United States
(12) Patent Application Publication
(10) Pub. No.: US 2017/0069014 A1
(43) Pub. Date: Mar. 9, 2017

(54) METHOD AND SYSTEM FOR INTELLIGENT STORAGE AND DISTRIBUTION OF MEDIA KEYS FOR CONTENT DELIVERY

(71) Applicant: MasterCard International Incorporated, Purchase, NY (US)

(72) Inventor: Michael MINELLI, Pleasantville, NY (US)

(73) Assignee: MasterCard International Incorporated, Purchase, NY (US)

(21) Appl. No.: 15/260,851

(22) Filed: Sep. 9, 2016

Related U.S. Application Data
(60) Provisional application No. 62/216,302, filed on Sep. 9, 2015.

(51) Int. Cl. G06Q 30/06; G06Q 20/12; G06F 17/30

(52) U.S. Cl. CPC G06Q 30/0635; G06F 17/30038; G06F 17/3005; G06F 17/30035; G06Q 20/123

(57) ABSTRACT

A method for providing media keys for content delivery includes: receiving a media purchase notification from each of at least two content purchasing entities, each notification including a media identifier, media key, associated platform identifier, and a common account identifier; storing, in an account profile, the common account identifier, media identifier, media key, and associated platform identifier included in each media purchase notification; receiving a content delivery request, the request including the common account identifier and a specific platform identifier; identifying, in the account profile, at least one media identifier and media key that is associated with the specific platform identifier; and transmitting a response to the content delivery request to a content delivering entity associated with the specific platform identifier, the response including the identified at least one media key.

### FIELD

The present disclosure relates to the automated distribution and control of media keys from computer systems of content purchasing entities to consumers to enable the delivery of content from a plurality of different content delivery entities, specifically the use of a centralized repository of media keys for the intelligent storage and distribution of the media keys to accomplish content delivery from the plurality of different delivering entities.

### BACKGROUND

The sale and delivery of media content, such as movies, television shows, music, lectures, video games, presentations, etc. is a billion dollar industry. As technology has improved, the bandwidth and speeds available for the delivery content have drastically increased, as have the number of devices capable of receiving the content for enjoyment by the end user. In such a burgeoning industry, a vast number of content delivery platforms have been established, such as Netflix®, Amazon®, iTunes®, Hulu®, Sling®, Crackle®, etc. Unfortunately, these content delivering entities often have exclusive deals with the owners of content, such that certain content may only be delivered by that specific entity. In addition, there are instances where multiple content delivering entities may each have access available to the same content. As a result, a consumer may have to use multiple content delivery platforms, which, at the same time, may cause them to lose track of what content that have purchased and on what platform that content is available.

Some methods have been developed to enable consumers to search for what platforms have what content generally available. For example, some smart televisions and other streaming devices enable a user to search for specific content, and will display each of the content delivery platforms that have the content available. However, such methods lack the ability to inform the consumer if they have already purchased that content on any available platform. Furthermore, such methods operate by contacting each of the content delivery platforms to identify changes in available content, either at the time of the search or periodically for indexing. Such decentralized storage of content ownership data can thus make it difficult, time consuming, and inefficient for a consumer to be able to keep track of their purchased content.

Thus, there is a need for a technical solution whereby a centralized repository may be used to store media keys and other information for a consumer for media associated with a plurality of different content delivery entities.

### SUMMARY

The present disclosure provides a description of systems and methods for providing media keys for content delivery, where the media keys are associated with a plurality of different content delivery platforms. By having a centralized repository for media keys, a consumer may more easily keep track of what content they own, without having to remember which content delivery platform the content is available for delivery through. In addition, the centralized repository makes it easier for content delivery platforms to deliver content to the end users, as they can rely on the centralized repository to confirm when a user has access to content, which can increase system effectiveness and efficiency.

A method for providing media keys for content delivery includes: receiving, by a receiving device of a processing server, a media purchase notification from each of at least two content purchasing entities, wherein each media purchase notification includes at least a media identifier, media key, an associated platform identifier, of a plurality of platform identifiers, associated with the respective content purchasing entity, and an account identifier, the account identifier in each of the at media purchase notifications being a common account identifier; executing, by a querying module of the processing server, a first query on an account database of the processing server to store, in an account profile of the account database, at least the media identifier, media key, and associated platform identifier included in each of the media purchase notifications and the common account identifier, wherein the account profile is a structured data set related to a transaction account; receiving, by the receiving device of the processing server, a content delivery request, wherein the content delivery request includes at least the common account identifier and a specific platform identifier; executing, by the querying module of the processing server, a second query on the account database to identify, in the account profile, at least one media identifier and media key that is associated with the specific platform identifier; and electronically transmitting, by a transmitting device of the processing server, a response to the content delivery request to a content delivering entity associated with the specific platform identifier, wherein the response includes at least the identified at least one media key.

A system for providing media keys for content delivery includes: a transmitting device of a processing server; a receiving device of the processing server configured to receive a media purchase notification from each of at least two content purchasing entities, wherein each media purchase notification includes at least a media identifier, media key, an associated platform identifier, of a plurality of platform identifiers, associated with the respective content purchasing entity, and an account identifier, the account identifier in each of the at media purchase notifications being a common account identifier; a querying module of the processing server configured to execute a first query on an account database of the processing server to store, in an account profile of the account database, at least the media identifier, media key, and associated platform identifier included in each of the media purchase notifications and the common account identifier, wherein the account profile is a structured data set related to a transaction account, wherein the receiving device of the processing server is further configured to receive a content delivery request, wherein the content delivery request includes at least the common account identifier and a specific platform identifier, the querying module of the processing server is further configured to execute a second query on the account database to identify, in the account profile, at least one media identifier and media key that is associated with the specific platform identifier, and the transmitting device of the processing server is configured to electronically transmit a response to the content delivery request to a content delivering entity associated with the specific platform identifier, wherein the response includes at least the identified at least one media key.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing media keys for content delivery in accordance with exemplary embodiments.

FIG. 2 is a block diagram illustrating the processing server of FIG. 1 for the providing of media keys for content delivery in accordance with exemplary embodiments.

FIGS. 3A and 3B are a flow diagram illustrating a process for the delivery of media keys for content delivery using the system of FIG. 1 in accordance with exemplary embodiments.

FIG. 4 is a diagram illustrating data storage and exchange to accomplish the providing of media keys for content delivery in the system of FIG. 1 in accordance with exemplary embodiments.

FIG. 5 is a flow chart illustrating an exemplary method for providing media keys for content delivery in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

### System for Providing Media Keys for Content Delivery

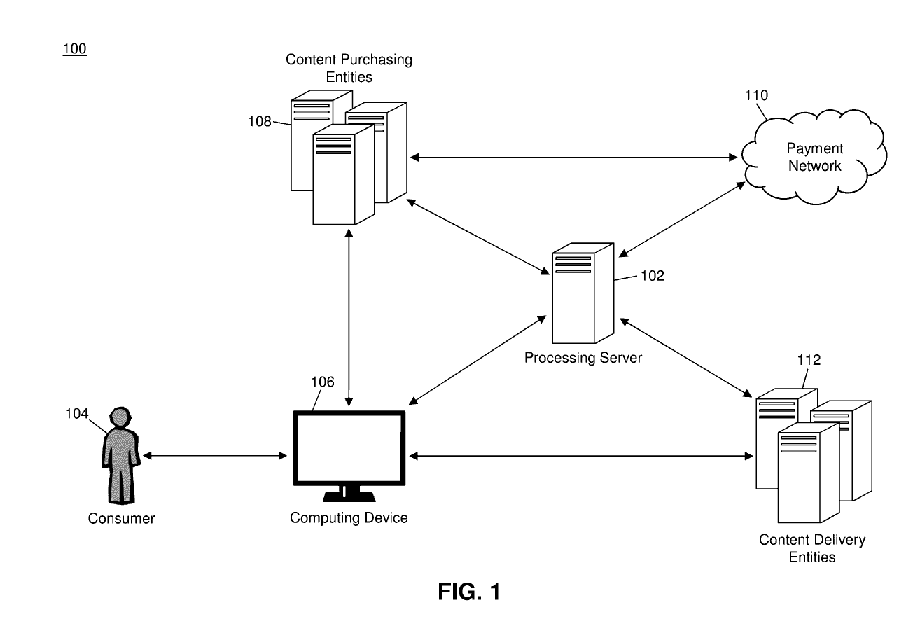

FIG. 1 illustrates a system 100 for the centralized storage and distribution of media keys for content delivery from a plurality of different content delivery platforms to an end user device.

The system 100 may include a processing server 102. The processing server 102, discussed in more detail below, may be configured to operate as a centralized repository for the intelligent storage and distribution of media keys for the delivery of content to a consumer 104. The consumer 104 may possess one or more computing devices 106 that may be used to receive and display or otherwise access content delivered to the computing device 106. Computing devices 106 may include, for example, desktop computers, laptop computers, notebook computers, tablet computers, cellular phones, smart phones, smart watches, smart televisions, set top boxes, streaming devices, wearable computing devices, implantable computing devices, etc. Content that may be delivered using the systems and methods discussed herein may include movies, television shows, music, lectures, presentations, books, video games, software, updates, etc.

In the system 100, the consumer 104 may purchase content from one of a plurality of content purchasing entities 108. Content purchasing entities 108 may be entities that have content available for purchase by the consumer 108 that can be distributed to the consumer's computing devices 106 from an associated content delivery entity 112. In some embodiments, a content purchasing entity 108 may be the content delivery entity 112 for any content purchased therefrom. In other embodiments, the content purchasing entity 108 may be separate from the content delivery entity 112, such as an owner of media content that is licensed to a separate content delivery entity 112 for delivery. For example, the content purchasing entity 108 may be a film studio from which the consumer 104 may purchase a film, while the content delivery entity 112 that distributes the film to the consumer's computing device 106 using its content delivery platform is a separate entity that has a license for distribution of that film from the film studio.

Once the consumer 104 purchases content from a content purchasing entity 108, the processing server 102 may be notified of the purchase. In one embodiment, the content purchasing entity 108 may notify the processing server 102 directly. For instance, the content purchasing entity 108 may electronically transmit a data signal to the processing server 102 using a suitable communication network and method, where the data signal is superimposed or otherwise encoded with at least an identifier associated with the consumer 104, a platform identifier associated with the content delivery entity 112 that is to deliver the purchased content, and a media identifier associated with the purchased content. The identifier associated with the consumer 104 may be a primary account number associated with a transaction account used to fund the payment transaction that was processed for the purchase of the content, or may be another unique value suitable for identification of the consumer 104, such as a registration number, serial number, e-mail address, username, etc. In some cases, the account identifier may be a hash of the primary account number, such as may be generated via application of one or more hashing algorithms to the primary account number.

In another embodiment, the processing server 102 may be notified of the purchase of content via receipt of a transaction message for the payment transaction that was processed for purchase of the content. For instance, the consumer 104 may initiate a payment transaction with the content purchasing entity 108 for purchase of the content, with the content purchasing entity 108 operating as a merchant for the payment transaction. The content purchasing entity 108, or an entity on behalf thereof, may submit a transaction message for the payment transaction to a payment network 110 for processing. Transaction messages may be specially formatted data messages that are formatted pursuant to one or more standards governing the exchange of financial transaction messages, such as the International Organization of Standardization's ISO 8583 or 20022 standards. Transaction messages may include at least a message type indicator indicative of a type of the transaction message, such as an authorization request or response, and a plurality of data elements, each data element being configured to store data related to the payment transaction. In some embodiments, a transaction message may include one or more bitmaps, which may be configured to indicate the data elements included in the transaction message and the data stored therein.

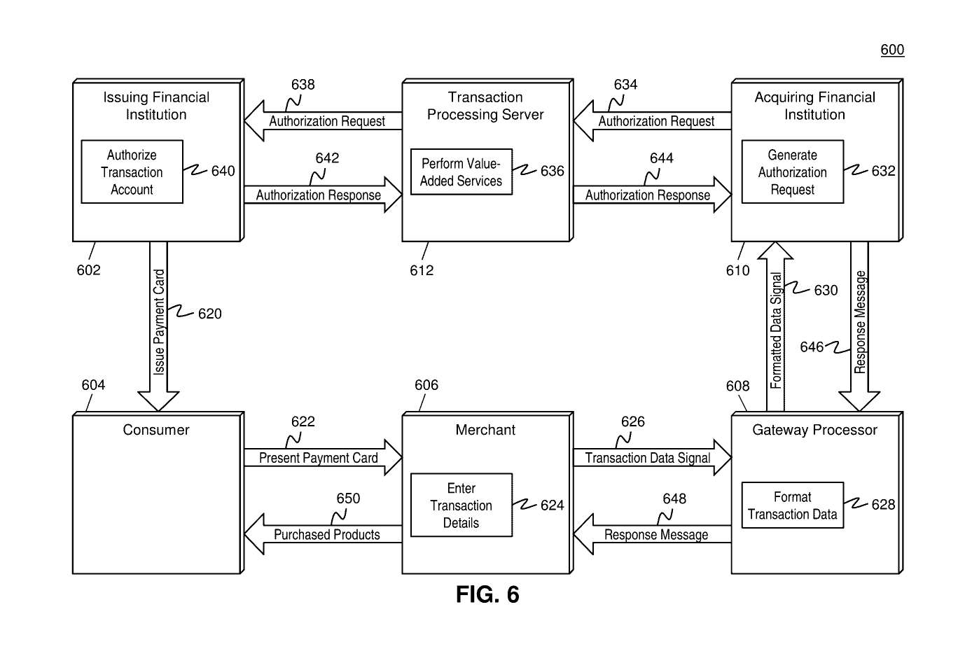

The payment network 110 may receive the transaction message from the content purchasing entity 108 or other associated entity for the payment transaction for the purchase of the content. The transaction message may be an authorization request, where the data elements may be configured to store at least the primary account number associated with the transaction account used to fund the payment transaction. In some cases, a data element configured to store an alternative account identifier may also be included therein. The payment network 110 may process the payment transaction using traditional methods or systems, such as discussed in more detail below with respect to the process 600 illustrated in FIG. 6. Following successful authorization of the payment transaction, the payment network 110 may electronically transmit the transaction message to the processing server 102 using a suitable communication network and method. In some cases, the processing server 102 may be a part of the payment network 110 and may receive the transaction message using an internal communication network. In other cases, the processing server 102 may be external from the payment network 110 and may receive the transaction message using another suitable type of communication network, such as the payment rails associated with the payment network 110.

The processing server 102 may receive the transaction message, which may be used to identify the purchase of content by the consumer 104. In one embodiment, the data elements included in the transaction message may be configured to store the media identifier associated with the purchased content. For instance, the media identifier may be included in Level 3 data stored in one or more data elements included in the transaction message. In another example, a data element may include the media identifier or another value associated with the purchased content for use in identification thereof, such as a name, universal product code, stock-keeping unit, etc. In another embodiment, the data elements may be configured to store a transaction identifier or other unique value associated with the payment transaction, such as may be supplied by or otherwise available to the content purchasing entity 108. In such an embodiment, the processing server 102 may electronically transmit the transaction identifier to the content purchasing entity 108, which may respond with the media identifier associated with the content purchased in the corresponding payment transaction. In cases where the content purchasing entity 108 and/or processing server 102 may use an account identifier alternative to the primary account number, the processing server 102 may be configured to hash the primary account number to identify the account identifier. In some instances, such hashing may be performed upon receipt of the transaction message, to prevent the storage or usage of the primary account number or other potential personally identifiable information.

When the consumer 104 wishes to access their purchased content, the consumer 104 may use their computing device 106 to request the content. In some embodiments, the consumer 104 may request the content from the associated content delivery entity 112. In such an embodiment, the content delivery entity 112 may electronically transmit a media request to the processing server 102 using a suitable communication network and method, where the media request includes at least the account identifier associated with the consumer 104, the platform identifier associated with the content delivery entity 112, and the media identifier associated with the requested content.

The processing server 102 may respond to the media request with a media key associated with the requested content and the consumer 104, where the media key may be used by the content delivery entity 112 to verify the consumer's ownership of the requested content. In some cases, the media key may be a unique value associated with the combination of the consumer 104 and the requested content. In other cases, the media key may be an encryption key used to decrypt the content for delivery and/or access, a key used to generate a digital signature for verification by the content deliver entity 112, or some other value that may be used by the content delivery entity 112 in performing verification using suitable methods.

In some embodiments, the processing server 102 may receive the media key along with the media identifier when first informed of the purchase by the content purchasing entity 108. In other embodiments, the processing server 102 may receive the media key along with the media identifier when requested following the receipt of a transaction message for the purchase of content. In yet other embodiments, the processing server 102 may receive the media key upon request after receiving a media request from the content delivery entity 112. For example, the processing server 102 may receive the media request, and then may electronically transmit a key request to the content purchasing entity 108 associated therewith, where the key request includes at least the account identifier, platform identifier, and media identifier. The content purchasing entity 108 may respond with the media key, which may be forwarded to the content delivery entity 112 by the processing server 102. Upon receipt of the media key, the content delivery entity 112 may then distribute the requested content to the computing device 106 using suitable methods. The consumer 104 may then be free to enjoy their purchased content.

In some embodiments, the processing server 102 may also be configured to deliver content, in addition, or alternative, to the content delivery entities 112. For instance, the processing server 102 may locally store content such that, when a media request is received from the content delivery entity 112 and/or computing device 106, the processing server 102 may distribute the requested content directly to the computing device 106. In some instances, the processing server 102 may provide additional content, which may be electronically transmitted to the content delivery entity 112 with the media key, for distribution to the computing device 106 along with the requested content. The additional content may include, for example, advertisements, offers, previews (e.g., teasers, trailers, etc.) for other purchasable content, etc. In some cases, advertisements or other additional content may be targeted to the consumer 104 to whom the content is being distributed. For example, targeting may be based on the consumer's purchased content, their requested content, their purchase behaviors (e.g., as identified by the payment network 110 or a third party entity associated therewith), consumer-supplied preferences, or other suitable criteria.

In some embodiments, the processing server 102 may be configured to enable the purchase of content via a third party merchant as part of a traditional payment transaction. For instance, the consumer 104 may visit a merchant that is running a promotion associated with a content purchasing entity 108 and/or content delivery entity 112, where the consumer 104 may be able to purchase content from the merchant as part of their usual purchase. For example, the consumer 104 may purchase take-out food from the merchant, with the consumer 104 being provided a special offer to also purchase a movie for streaming via a content delivery entity 112, to enjoy with their meal. The consumer 104 may indicate a desire to purchase the content to the merchant (e.g., to an employee of the merchant, who may enter the indication into a point of sale, or directly into a point of sale by the consumer 104, such as by being prompted during payment). The payment transaction may then be processed, with the merchant notifying the processing server 102 of the account identifier for the consumer 104 as well as the media identifier and platform identifier for the content (e.g., received from the content delivery entity 112 or applicable entity when starting the promotion). In such an embodiment, a consumer 104 may purchase content to be associated with their account during a traditional payment transaction. In some situations, this may provide for even greater convenience to the consumer 104. For example, a consumer 104 may visit a drive-thru for a fast food restaurant and purchase a movie or album as part of their transaction, where the associated content delivery entity 112 may be notified and immediately make the content available for access via the consumer's vehicle's entertainment system or a device (e.g., smart phone, tablet computer, etc.) inside the vehicle. In some cases, content may be provided for free to the consumer 104 with a purchase or as a reward or prize. For instance, a movie may be given to the consumer 104 with a specific purchase at a merchant, where the movie is gifted via the addition of the media identifier associated with the movie to the consumer's profile with the processing server 102, thereby enabling access via the associated content delivery entity 112.

The methods and systems discussed herein enable the intelligent storage and distribution of media keys for the distribution of content to the computing devices 106 of an end consumer 104, which may have content purchased from a plurality of different content purchasing entities 108 and available for delivery through a plurality of different content delivery entities 112. The use of the processing server 102 as a centralized repository of the media keys may ensure that the consumer 104 may be able to identify content that has already been purchased to avoid the repurchasing of content, and may be able to easily identify the content delivery entity 112 associated with purchased content for requested, and, in some cases, may be able to request content directly from the processing server 102, which may notify the appropriate content delivery entity 112 providing for even greater consumer convenience. In addition, such methods also provide benefits to content delivery entities 112, as the content delivery entities 112 may utilize the processing server 102 for storage of media keys, as well as for the requesting of content, minimizing required network communications and bandwidth, which may increase resources available for content distribution.

### Processing Server

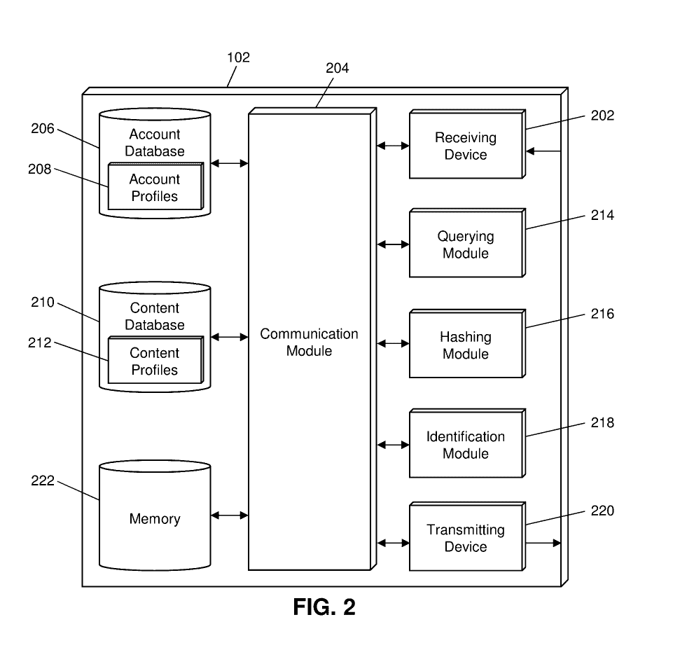

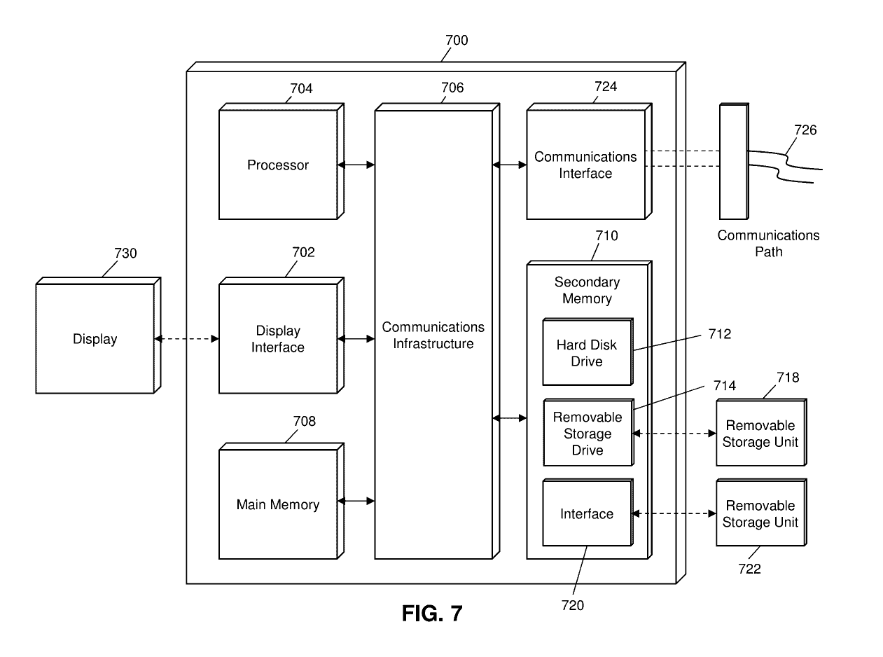

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data from computing devices 106, content purchasing entities 108, content delivery entities 112, payment networks 110, and other entities via one or more communication networks, such as local area networks, cellular communication networks, the Internet, etc. In some embodiments, the receiving device 202 may be comprised of multiple devices, such as different receiving devices for receiving data over different networks, such as a first receiving device for receiving data via the payment network 110 and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by content purchasing entities 108, which may be superimposed or otherwise encoded with account identifiers, media identifiers, platform identifiers, and/or media keys. The receiving device 202 may also be configured to receive data signals electronically transmitted by content delivery entities 112 and/or computing devices 106, which may be superimposed or otherwise encoded with platform identifiers, account identifiers, and media identifiers. In some embodiments, the receiving device 202 may also be configured to receive transaction messages from payment networks 110 via payment rails associated therewith, which may be included data elements configured to store primary account numbers, account identifiers, and/or additional data suitable for performing the functions discussed herein. In some cases, the receiving device 202 may be configured to receive data signals from third party entities that are superimposed or otherwise encoded with additional content, which may be distributed to computing devices 106 in addition to requested content.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, hashing module 216, identification module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account used to purchase content. The account profile 208 may include the account identifier for the related transaction account, and, in some instances, may include multiple account identifiers, such as in instances where accounts may be linked or multiple funding sources (e.g., transaction accounts) may be used to purchase content. Account profiles 208 may also include platform identifiers associated with content delivery entities 112 from whom content is delivered, media identifiers associated with content purchased by the consumer 104 for each content delivery entity 112 (e.g., where identifiers may be content delivery entity-specific), and, in some instances, media keys associated with purchase content.

In some embodiments, the processing server 102 may also include a content database 210. The content database 210 may be configured to store a plurality of content profiles 212 using a suitable data storage format and schema. The content database 210 may be a relational database that utilizes structured query language for the storage, identification, modifying, updating, accessing, etc. of structured data sets stored therein. Each content profile 212 may be a structured data set configured to store data related to additional content. A content profile 212 may include the additional content, information suitable for use in identifying the content (e.g., a unique content identifier), and criteria for identification of the additional content for distribution, such as target demographics, purchase behaviors, content preferences, etc.

The processing server 102 may include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 on which a purchase was made using the associated account identifier, for storage of the corresponding platform identifier, media identifier, and, if applicable, media key therein.

The processing server 102 may also include a hashing module 216. The hashing module 216 may be configured to generate hash values for use in performing the functions of the processing server 102 as discussed herein. The hashing module 216 may receive instructions, which may include data to be hashed, may generate a hash value via the application of one or more hashing algorithms thereto, and may output the generated hash value to another module or engine of the processing server 102. In some instances, the instructions may specify the hashing algorithm(s) to be used in generating the hash value. In other instances, the hashing module 216 may be configured to identify the one or more hashing algorithms that are used thereby. The hashing module 216 may be configured to generate an account identifier as a hash value via the application of one or more hashing algorithms to a primary account number, such as parsed from a transaction message, for use of the account identifier in performing the functions of the processing server 102 as discussed herein.

In some embodiments, the processing server 102 may also include an identification module 218. The identification module 218 may be configured to identify data for use by the processing server 102 in performing the functions discussed herein. The identification module 218 may receive instructions, may identify data based thereon, and may output the identified data to another module or engine of the processing server 102. In some cases, the instructions may include data to be used in performing the data identification. In other cases, the identification module 218 may be configured to retrieve (e.g., via the querying module 214) other data to use in performing the identification. For instance, the identification module 218 may be configured to identify additional content stored in the content database 210 to accompany requested content based on the associated criteria and the consumer 104 that requested the content, and may submit instructions to the querying module 214 to query the content database 210 to identify the additional content for transmission to the content delivery entity 112 for distribution with the requested content.

The processing server 102 may also include a transmitting device 220. The transmitting device 220 may be configured to transmit data over one or more networks via one or more network protocols. In some embodiments, the transmitting device 220 may be configured to transmit data to computing devices 106, content purchasing entities 108, payment networks 110, content delivery entities 112, and other entities via one or more networks, such as local area networks, cellular communication networks, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to content purchasing entities 108, which may be superimposed or otherwise encoded with media key requests, which may include at least an account identifier and a media identifier, and may further include a platform identifier. The transmitting device 220 may also be configured to electronically transmit data signals to content delivery entities 112, such as may be superimposed or otherwise encoded with media keys, for use in accessing content to be delivered to a computing device 106, where the media key may be accompanied by additional data, such as an account identifier. In some embodiments, the transmitting device 220 may also be configured to electronically transmit data signals superimposed or otherwise encoded with content, such as requested content or additional content, which may be transmitted to a content delivery entity 112 and/or computing device 106.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein.

### Process for Registration and Distribution of Purchased Content

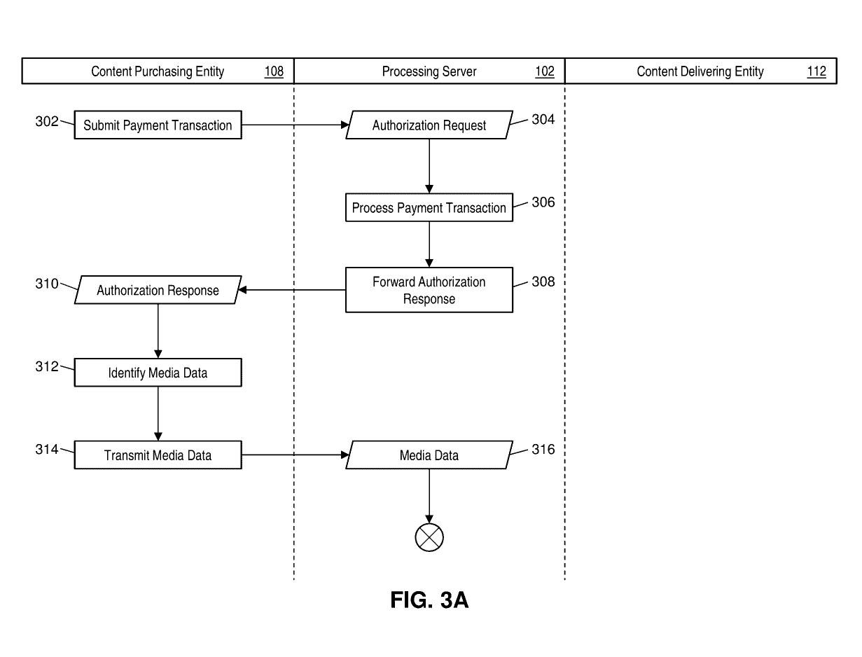

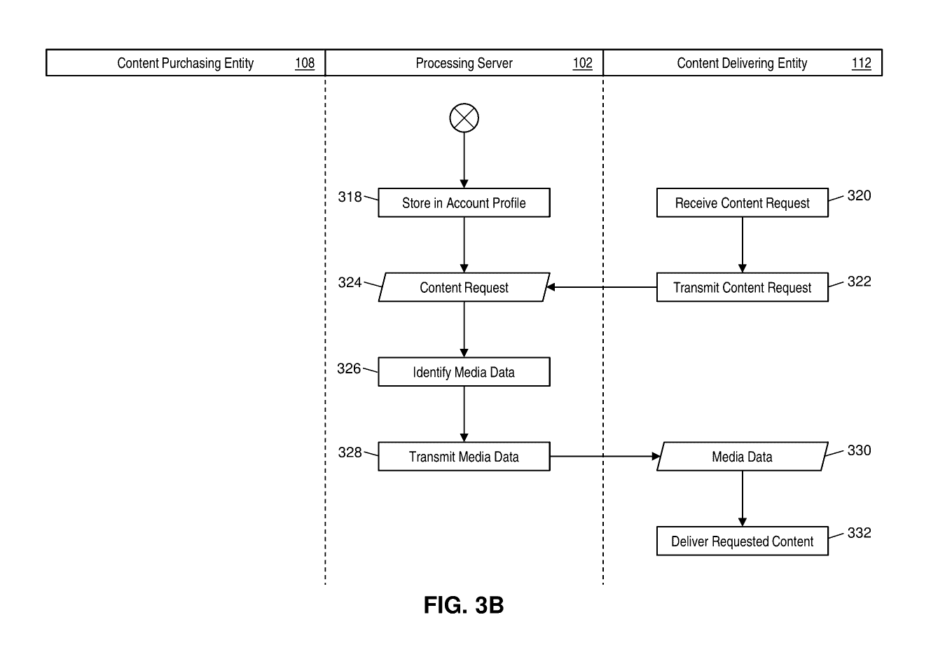

FIGS. 3A and 3B illustrate a process for the registration of purchased content using the centralized repository of the processing server 102 of the system 100, and the distribution of the purchased content to a user computing device 106 upon request based thereon.

In step 302, a content purchasing entity 108, or an entity associated therewith, such as an acquiring financial institution may submit a payment transaction to the processing server 102, as part of the payment network 110, for processing. In step 304, the receiving unit 202 of the processing server 102 may receive the authorization request. The authorization request may be a transaction message formatted pursuant to one or more standards, such as the ISO 8583 or 20022 standards, that includes a plurality of data elements including at least a first data element configured to store a primary account number and a plurality of additional data elements configured to store additional transaction data. In some instances, the additional data elements may be configured to store media data, such as a media identifier, media key, platform identifier, and/or account identifier. In step 306, the processing server 102, as part of the payment network 110, may process the payment transaction using traditional methods and systems. As part of the processing, in step 308, the transmitting device 220 of the processing server 102 may forward an authorization response to the content purchasing entity 108, which may include a data element configured to store a response code indicating that the payment transaction was approved.

In step 310, the content purchasing entity 108 may receive the authorization response. Then, in step 312, the content purchasing entity 108 may identify media data for the media purchased by the consumer 106 as part of the payment transaction. In step 314, the content purchasing entity 108 may electronically transmit the media data to the processing server 102 using a suitable communication network and method. In step 316, the receiving device 202 of the processing server 102 may receive the media data, which may include at least the account identifier, platform identifier, and media identifier for the purchased content. In some embodiments, the media data may also include a media key unique to the consumer's purchase of the specific content. In step 318, the querying module 214 of the processing server 102 may execute a query on the account database 206 to store the platform identifier and media identifier in the account profile 208 associated with the consumer 104, identified based on the account identifier. In instances where the media data includes the media key, the media key may also be stored in the account profile 208.

In step 320, the content delivering entity 112 may receive a content request from the consumer 104 via a computing device 106 associated therewith, for the request to view or otherwise access purchased content. The request may include at least the consumer's account identifier and the media identifier of the requested content or data for use in identification thereof, such as a content name. In step 322, the content delivering entity 112 may electronically transmit a content request to the processing server 102 using a suitable communication network and method, where the content request includes the account identifier and media identifier, as well as the platform identifier associated with the content delivering entity 112. In step 324, the receiving device 202 of the processing server 102 may receive the content request.

In step 326, the querying module 214 of the processing server 102 may execute a query on the account database 206 to identify media data for the requested content, where the media data is identified based on the account identifier, platform identifier, and media identifier included in the received content request. In embodiments where the media key was already provided to the processing server 102, identification of the media data may include identification of the media key associated therewith in the account profile 208. In other embodiments, step 326 may include the electronic transmission (e.g., by the transmitting device 220 of the processing server 102) of a key request to the content purchasing entity 108, which may include the account identifier, platform identifier, and media identifier, and receipt (e.g., by the receiving device 202 of the processing server 102) of the media key therefrom. In embodiments where the processing server 102 may store the requested content, step 326 may include the execution of a query on the content database 210 by the querying module 214 of the processing server 102 to identify a content profile 212 related to the requested content based on the media identifier and platform identifier and identification of the content stored therein.

In step 328, the transmitting device 220 of the processing server 102 may electronically transmit the media data, including the media key and, if applicable, the requested content, to the content delivering entity 112. In step 330, the content delivering entity 112 may receive the media data. In step 332, the content delivering entity 112 may deliver the requested content to the computing device 106 as requested. In instances where the content was not provided by the processing server 102, the content delivering entity 112 may first identify the content based on the media identifier. In some cases, the content delivering entity 112 may also verify the media key provided by the processing server 102 prior to delivery of the requested content.

### Data Relationships for Delivery of Media Content

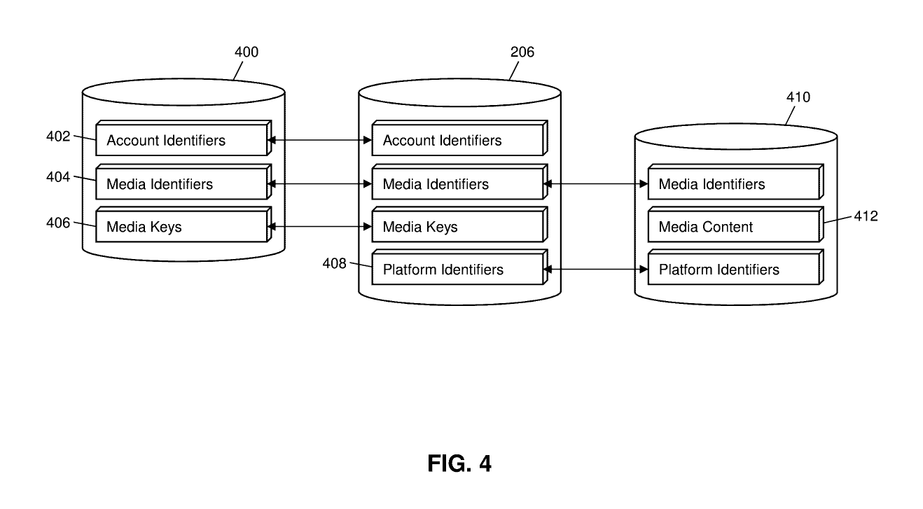

FIG. 4 illustrates relationships of data between the processing server 102, content purchasing entities 108, and content delivery entities 112 of the system 100, as discussed above. It will be apparent to persons having skill in the relevant art that the data relationships illustrated in FIG. 4 and discussed below are provided as example illustrations only, and that other implementations may be suitable for performing the functions discussed herein.

As illustrated in FIG. 4 and discussed above, the processing server 102 may include an account database 206, which may be configured to store a plurality of account identifiers 402, media identifiers 404, media keys 406, and platform identifiers 408. The account identifiers 402 may be identifiers associated with a consumer account, such as a transaction account or other content account, and used in identification of actions associated therewith, such as for identification during the purchasing of content, exchange of media data, requesting of content, and delivery of content. Account identifiers 402 may include, for instance, primary account numbers, identification numbers, registration numbers, usernames, e-mail addresses, telephone numbers, etc. The content purchasing entities 108 may include a database 400, which may also be configured to store the account identifiers 402. Account identifiers 402 may be stored by the content purchasing entities 108 for identification and use thereof when providing media data to the processing server 102 for use in performing the functions discussed herein.

Media identifiers 404 may be unique values associated with content, which may be used in the identification thereof. In some cases, a media identifier 404 may be unique to a combination of the content and a content delivery entity 112. For instance, a single movie may have a first media identifier associated therewith used by a first content delivery entity 112, and a second media identifier also associated therewith used by a second content delivery entity 112. Media identifiers 404 may be any type of unique value suitable for performing the functions discussed herein, such as an identification number, serial number, etc. The database 400 of the content purchasing entities 108 may also include the media identifiers 404. Media identifiers 404 may also be included in a database 410 of the content delivery entities 112, such as for use in identifying media that is requested and for which media keys are requested.

Media keys 406 may be unique values associated with a combination of a consumer 104 and requested content. In some instances, a media key 406 may be an encryption key used to decrypt the content for delivery and/or access, a key used to generate a digital signature for verification by the content deliver entity 112, or some other value that may be used by the content delivery entity 112 in performing verification using suitable methods. Media keys 406 may be stored in the account database 206 of the processing server 102 as well as the database 400 of the content purchasing entities 108, for distribution to content delivery entities 112 for access of the associated content upon request by a consumer 104.

Platform identifiers 408 may be unique values associated with a content delivery entity 112 for identification thereof. Platform identifiers 408 may be used in instances where a single item of content may have multiple media identifiers 404 associated therewith, and/or for use in identifying media keys 406 based on association therewith and a content delivery entity 112. Platform identifiers 408 may be included in the account database 206 of the processing server 102, and a platform identifier 408 associated with a content delivery entity 112 may also be included in its associated database 410.

### Exemplary Method for Providing Media Keys for Content Delivery

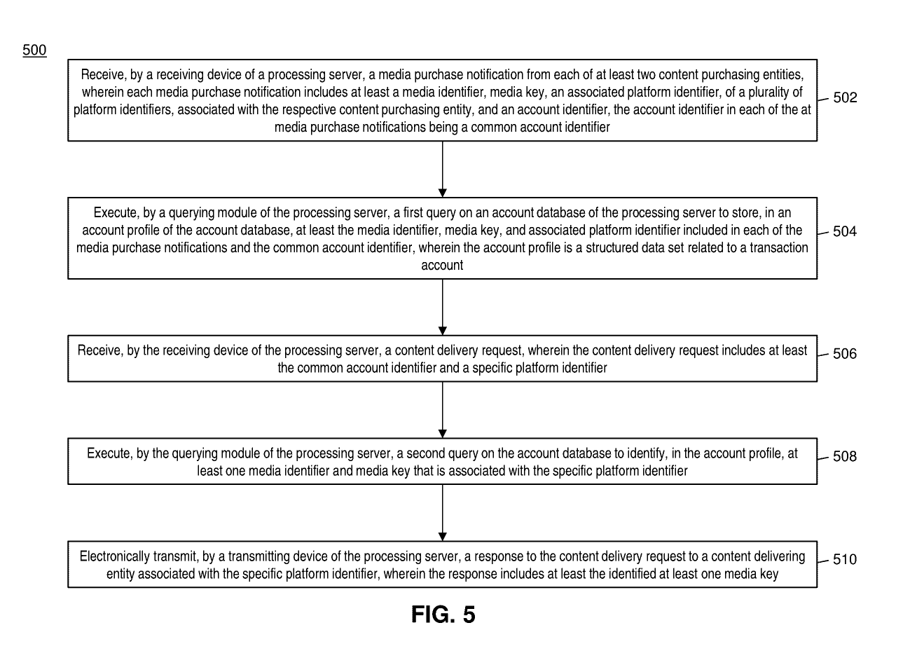

FIG. 5 illustrates a method 500 for the providing of media keys from a centralized repository that are associated with a plurality of different content purchasing entities to a plurality of different content delivery entities for delivery of content related thereto.

In step 502, a media purchase notification may be received by a receiving device (e.g., the receiving device 202) of a processing server (e.g., the processing server 102) from each of at least two content purchasing entities (e.g., the content purchasing entities 108), wherein each media purchase notification includes at least a media identifier, media key, an associated platform identifier, of a plurality of platform identifiers, associated with the respective content purchasing entity, and an account identifier, the account identifier in each of the at media purchase notifications being a common account identifier. In step 504, a first query may be executed on an account database (e.g., the account database 206) of the processing server by a querying module (e.g., the querying module 214) of the processing server to store, in an account profile (e.g., account profile 208) of the account database, at least the media identifier, media key, and associated platform identifier included in each of the media purchase notifications and the common account identifier, wherein the account profile is a structured data set related to a transaction account.

In step 506, a content delivery request may be received by the receiving device of the processing server, wherein the content delivery request includes at least the common account identifier and a specific platform identifier. In step 508, a second query may be executed by the querying module of the processing server on the account database to identify, in the account profile, at least one media identifier and media key that is associated with the specific platform identifier. In step 510, a response to the content delivery request may be electronically transmitted by a transmitting device (e.g., the transmitting device 220) of the processing server 102 to a content delivering entity (e.g., the content delivering entity 112) associated with the specific platform identifier, wherein the response includes at least the identified at least one media key.

In one embodiment, the response may further include the identified at least one media identifier. In some embodiments, the content delivery request may further includes a specific media identifier, the identified at least one media identifier may include the specific media identifier, and the identified at least one media key included in the response may be associated with the specific media identifier. In one embodiment, the account identifier may be a primary account number.

In some embodiments, the method 500 may further include receiving, by the receiving device of the processing server, a transaction message related to a payment transaction, wherein the transaction message is formatted pursuant to one or more standards and includes at least a plurality of data elements including at least a first data element configured to store the common account identifier, a second data element configured to store a platform identifier of the plurality of platform identifiers, and one or more additional data elements configured to store transaction data. In a further embodiment, one of the media purchase notifications may be the transaction message, and the media identifier and media key included in the media purchase notification may be stored in one or more of the one or more additional data elements included in the transaction message. In another further embodiment, the transaction message may be received from one of the at least two content purchasing entities.

In one embodiment, the method 500 may also include: generating, by a hashing module (e.g., the hashing module 216) of the processing server, a hashed identifier based on application of one or more hashing algorithms to the common account identifier; and electronically transmitting, by the transmitting device of the processing server, a response to each media purchase notification, wherein the response includes at least the hashed identifier, wherein the hashed identifier is stored in the account profile in place of the common account identifier. In some embodiments, the content delivery request may be received from the content delivering entity. In one embodiment, the content delivery request may be received from a computing device not associated with the content delivering entity.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, content purchasing entities 108, consumer 104, payment network 110, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3A, 3B, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8583 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8583 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly. The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, 5, and 6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3A, 3B, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for providing media keys for content delivery. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing media keys for content delivery, comprising:
receiving, by a receiving device of a processing server, a media purchase notification from each of at least two content purchasing entities, wherein each media purchase notification includes at least a media identifier, media key, an associated platform identifier, of a plurality of platform identifiers, associated with the respective content purchasing entity, and an account identifier, the account identifier in each of the at media purchase notifications being a common account identifier;
executing, by a querying module of the processing server, a first query on an account database of the processing server to store, in an account profile of the account database, at least the media identifier, media key, and associated platform identifier included in each of the media purchase notifications and the common account identifier, wherein the account profile is a structured data set related to a transaction account;
receiving, by the receiving device of the processing server, a content delivery request, wherein the content delivery request includes at least the common account identifier and a specific platform identifier;
executing, by the querying module of the processing server, a second query on the account database to identify, in the account profile, at least one media identifier and media key that is associated with the specific platform identifier; and
electronically transmitting, by a transmitting device of the processing server, a response to the content delivery request to a content delivering entity associated with the specific platform identifier, wherein the response includes at least the identified at least one media key.

2. The method of claim 1, wherein the response further includes the identified at least one media identifier.

3. The method of claim 1, wherein
the content delivery request further includes a specific media identifier,
the identified at least one media identifier includes the specific media identifier, and
the identified at least one media key included in the response is associated with the specific media identifier.

4. The method of claim 1, further comprising:
receiving, by the receiving device of the processing server, a transaction message related to a payment transaction, wherein the transaction message is formatted pursuant to one or more standards and includes at least a plurality of data elements including at least a first data element configured to store the common account identifier, a second data element configured to store a platform identifier of the plurality of platform identifiers, and one or more additional data elements configured to store transaction data.

5. The method of claim 4, wherein
one of the media purchase notifications is the transaction message, and
the media identifier and media key included in the media purchase notification are stored in one or more of the one or more additional data elements included in the transaction message.

6. The method of claim 4, wherein the transaction message is received from one of the at least two content purchasing entities.

7. The method of claim 1, wherein the account identifier is a primary account number.

8. The method of claim 1, further comprising:
generating, by a hashing module of the processing server, a hashed identifier based on application of one or more hashing algorithms to the common account identifier; and
electronically transmitting, by the transmitting device of the processing server, a response to each media purchase notification, wherein the response includes at least the hashed identifier, wherein
the hashed identifier is stored in the account profile in place of the common account identifier.

9. The method of claim 1, wherein the content delivery request is received from the content delivering entity.

10. The method of claim 1, wherein the content delivery request is received from a computing device not associated with the content delivering entity.

11. A system for providing media keys for content delivery, comprising:
a transmitting device of a processing server;
a receiving device of the processing server configured to receive a media purchase notification from each of at least two content purchasing entities, wherein each media purchase notification includes at least a media identifier, media key, an associated platform identifier, of a plurality of platform identifiers, associated with the respective content purchasing entity, and an account identifier, the account identifier in each of the at media purchase notifications being a common account identifier;
a querying module of the processing server configured to execute a first query on an account database of the processing server to store, in an account profile of the account database, at least the media identifier, media key, and associated platform identifier included in each of the media purchase notifications and the common account identifier, wherein the account profile is a structured data set related to a transaction account, wherein
the receiving device of the processing server is further configured to receive a content delivery request, wherein the content delivery request includes at least the common account identifier and a specific platform identifier,
the querying module of the processing server is further configured to execute a second query on the account database to identify, in the account profile, at least one media identifier and media key that is associated with the specific platform identifier, and
the transmitting device of the processing server is configured to electronically transmit a response to the content delivery request to a content delivering entity associated with the specific platform identifier, wherein the response includes at least the identified at least one media key.

12. The system of claim 11, wherein the response further includes the identified at least one media identifier.

13. The system of claim 11, wherein
the content delivery request further includes a specific media identifier,
the identified at least one media identifier includes the specific media identifier, and
the identified at least one media key included in the response is associated with the specific media identifier.

14. The system of claim 11, wherein the receiving device of the processing server is further configured to receive a transaction message related to a payment transaction, wherein the transaction message is formatted pursuant to one or more standards and includes at least a plurality of data elements including at least a first data element configured to store the common account identifier, a second data element configured to store a platform identifier of the plurality of platform identifiers, and one or more additional data elements configured to store transaction data.

15. The system of claim 14, wherein
one of the media purchase notifications is the transaction message, and
the media identifier and media key included in the media purchase notification are stored in one or more of the one or more additional data elements included in the transaction message.

16. The system of claim 14, wherein the transaction message is received from one of the at least two content purchasing entities.

17. The system of claim 11, wherein the account identifier is a primary account number.

18. The system of claim 11, further comprising:
a hashing module of the processing server configured to generate a hashed identifier based on application of one or more hashing algorithms to the common account identifier, wherein
the transmitting device of the processing server is further configured to electronically transmit a response to each media purchase notification, wherein the response includes at least the hashed identifier, and
the hashed identifier is stored in the account profile in place of the common account identifier.

19. The system of claim 11, wherein the content delivery request is received from the content delivering entity.

20. The system of claim 11, wherein the content delivery request is received from a computing device not associated with the content delivering entity.
